(19) United States
(12) Patent Application Publication
(10) Pub. No.: US 2025/0203234 A1
(43) Pub. Date: Jun. 19, 2025

(54) IMAGING DEVICE

(71) Applicant: Panasonic Intellectual Property Management Co., Ltd., Osaka (JP)

(72) Inventors: MAKOTO SHOUHO, Osaka (JP); YOSHIAKI SATOU, Kyoto (JP); YASUO MIYAKE, Osaka (JP)

(21) Appl. No.: 19/071,839

(22) Filed: Mar. 6, 2025

Related U.S. Application Data
(63) Continuation of application No. PCT/JP2023/024904, filed on Jul. 5, 2023.

(30) Foreign Application Priority Data
Sep. 30, 2022 (JP) 2022-157951

(51) Int. Cl. H04N 25/65; H04N 25/616; H04N 25/76; H04N 25/771; H04N 25/78

(52) U.S. Cl. CPC H04N 25/65; H04N 25/771; H04N 25/7795; H04N 25/616; H04N 25/78

(57) ABSTRACT

An imaging device includes multiple pixels arranged in a matrix of rows and columns, a vertical signal line arranged for each column of the pixels, and a controller. Each pixel includes a photoelectric converter that converts light into signal charges. The controller causes each pixel to output to the vertical signal line a pixel signal corresponding to an amount of signal charges accumulated in the pixel and a reference signal after the pixel is reset. During a first period during which a first pixel at a first row is caused to output the pixel signal, the controller causes to output the pixel signal a second pixel that is arranged at a second row different from the first row and at a first column where the first pixel is arranged. The controller causes the second pixel to re-output the pixel signal before resetting the second pixel but after the first period.

### BACKGROUND

### 1. Technical Field

The present disclosure relates to an imaging device.

### 2. Description of the Related Art

Charge-coupled-device (CCD) image sensors and complementary metal-oxide-semiconductor (CMOS) image sensors are widely used in digital cameras.

Japanese Unexamined Patent Application Publication No. 2016-127593 discloses an imaging device that forms a feedback loop on each pixel in an imaging region and cancels reset noise through negative feedback.

Japanese Unexamined Patent Application Publication No. 2010-259027 discloses an imaging device that has a faster pixel mixing function.

### SUMMARY

One non-limiting and exemplary embodiment provides imaging devices featuring noise reduction characteristics.

In one general aspect, the techniques disclosed here feature an imaging device including: multiple pixels arranged in a matrix of rows and columns; a signal line arranged for each column of the pixels; and a controller, wherein each of the pixels includes a photoelectric converter that converts light into signal charges, and wherein the controller causes each of the pixels to output to the signal line a pixel signal corresponding to an amount of the signal charges accumulated in the pixel and a reference signal after the pixel is reset, causes, during a first period during which a first pixel at a first row is caused to output the pixel signal, to output the pixel signal a second pixel that is arranged at a second row different from the first row and at a first column where the first pixel is arranged, and causes the second pixel to re-output the pixel signal before resetting the second pixel but after the first period.

An imaging device featuring noise reduction characteristics may be provided.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 schematically illustrates a configuration of an imaging device in a first embodiment;

FIG. 2 illustrates a circuit configuration of the imaging device in the first embodiment;

FIG. 3 illustrates a circuit configuration of each pixel in the imaging device in the first embodiment;

FIG. 4 is a timing chart of an operation example 1 of the imaging device in the first embodiment;

FIG. 5 is a timing chart of an operation example 2 of the imaging device in the first embodiment;

FIG. 6 is a timing chart of an operation example 3 of the imaging device in the first embodiment;

FIG. 7 is a timing chart of an operation example 4 of the imaging device in the first embodiment;

FIG. 8 illustrates a circuit configuration of an imaging device in a second embodiment; and

FIG. 9 is a timing chart of an operation example of the imaging device in the second embodiment.

### DETAILED DESCRIPTIONS

### Underlying Knowledge Forming Basis of the Present Disclosure

Japanese Unexamined Patent Application Publication No. 2016-127593 discloses the technique that reduces reset noise using negative feedback. Further noise reduction characteristics are in demand in the imaging device.

In order to realize noise reduction characteristics in an imaging device, the inventors have focused on noise that is generated by an amplification transistor that outputs a signal corresponding to an amount of signal charges generated through photoelectric conversion. The noise generated by the amplification transistor may include, for example, 1/f noise and thermal noise. The inventors have studied reducing these noises and found the configuration in the disclosure.

### SUMMARY OF DISCLOSURE

Examples of an imaging device related to the disclosure are described below as a summary.

According to a first aspect of the disclosure, there is provided an imaging device including: multiple pixels arranged in a matrix of rows and columns; a signal line arranged for each column of the pixels; and a controller, wherein each of the pixels includes a photoelectric converter that converts light into signal charges, and wherein the controller causes each of the pixels to output to the signal line a pixel signal corresponding to an amount of the signal charges accumulated in the pixel and a reference signal after the pixel is reset, causes, during a first period during which a first pixel at a first row is caused to output the pixel signal, to output the pixel signal a second pixel that is arranged at a second row different from the first row and at a first column where the first pixel is arranged, and causes the second pixel to re-output the pixel signal before resetting the second pixel but after the first period.

In this way, pixel signals of the pixels at the first and second rows are concurrently output to the signal line and thus mixed. If an amplification transistor outputting a pixel signal is present as a result, an effective gate width of the amplification transistor is doubled, and thus the mutual conductance gm of the amplification transistor is multiplied by √2. Generally, random noise generated by the amplification transistor is proportional to 1/gm. Noise reduction characteristics may be realized by causing the pixel signals of the pixels at the two rows to be concurrently output to the signal line. Generally, settling time is also proportional to 1/gm. High-speed driving may thus be realized by causing the pixel signals of the pixels at the two rows to be concurrently output to the signal line.

In the imaging device according to a second aspect of the disclosure in view of the first aspect, the controller may reset the first pixel after causing the first pixel to output the pixel signal and may cause the first pixel to output the reference signal after the resetting.

Since the first pixel is able to output consecutively the pixel signal and the reference signal, a simpler circuit configuration may thus perform signal processing using the pixel signal and the reference signal.

The imaging device according to a third aspect of the disclosure in view of one of the first and second aspects may further include a signal processor wherein the signal processor generates image data in accordance with the pixel signals that are output by the first pixel and the second pixel during the first period and the reference signal output by the first pixel.

Since the image data is generated using a pixel signal that is a mixture of pixel signals of the pixels at the two rows in this way, the image data with noise reduced may be generated.

In the imaging device according to a fourth aspect of the disclosure in view of the first aspect, after causing the first pixel to output the reference signal, the controller may cause the first pixel to output the pixel signal after causing the first pixel to accumulate the signal charges.

Since a reset noise that is at the same level as in the reference signal output immediately before is superimposed on the pixel signal of the first pixel, the effect of the reset noise may be removed by subtracting the reference signal from the pixel signal and further noise reduction characteristics may thus be realized.

The imaging device according to a fifth aspect of the disclosure in view of one of the first and fourth aspects may further include a signal processor wherein the signal processor generates image data in accordance with the reference signal output by the first pixel, the reference signal output by the second pixel, and the pixel signals that are output by the first pixel and the second pixel during the first period.

The signal processor may thus generate the image data using the pixel signal that is a mixture of the pixel signals of the pixels at two rows and the reference signals of the pixels at the two rows. Since the use of the reference signals of the pixels at the two rows may remove the effect of the reset noise from the pixel signal that is the mixture of the pixel signals of the pixels at the two rows, further noise reduction characteristics may be realized.

The imaging device according to a sixth aspect of the disclosure in view of the fifth aspect may further include a memory that stores a signal corresponding to the reference signal.

The reference signals of the pixels at the two rows may thus be easily used in the signal processing.

In the imaging device according to a seventh aspect of the disclosure in view of one of the first through sixth aspects, the controller causes to output during the first period the pixel signal a third pixel that is arranged at the first column and at a third row different from the first row and the second row, and causes the third pixel to re-output the pixel signal before resetting the third pixel but after the first period.

In this configuration, the pixel signals of the pixels at the first, the second and third rows are concurrently output to the signal line and thus mixed. If an amplification transistor outputting a pixel signal is present as a result, an effective gate width of the amplification transistor is tripled, and thus the mutual conductance gm of the amplification transistor is multiplied by √3. Further noise reduction characteristics and high-speed driving may thus be realized.

The imaging device according to an eighth aspect of the disclosure in view of one of the first through seventh aspects may further include a switch connected between the signal line arranged for the first column and the signal line arranged for a second column different from the first column, wherein the controller causes the switch to conduct during the first period.

The pixel signals of the pixels at the two columns are mixed with the adjacent two signal lines conducted to each other. Further noise reduction characteristics and high-speed driving may thus be realized.

In the imaging device according to a ninth aspect of the disclosure in view of one of the first through eighth aspects, each of the pixels includes a feedback circuit that negatively feeds back reset noise.

The reset noise may thus be reduced, leading to further noise reduction characteristics.

In the imaging device according to a tenth aspect of the disclosure in view of one of the first through ninth aspects, the controller causes the second pixel not to output the reference signal during a second period during which the first pixel is caused to output the reference signal.

The configuration described above enables the second pixel to be reset at a timing different from a timing of the first pixel, increasing the degree of freedom of the output timing of the pixel signal and the reference signal of the second pixel.

Embodiments of the disclosure are described below with reference to the drawings. Each of the embodiments described below represents a general or specific example of the disclosure. Numerical values, shapes, materials, elements, a layout position of the elements, a connection configuration of the elements, steps and the order of the steps in the embodiments are described for exemplary purposes only, and are not intended to limit the disclosure. A variety of aspects described below in the specification may be combined with each other as long as no contradiction arises. From among the elements of the embodiments, elements not described in independent claims, may be optional elements. In the discussion that follows, elements having a substantially identical function may be denoted by a common reference numeral and the duplication of the discussion thereof may be avoided. A subset of the elements may not be illustrated to avoid the complexity of drawings.

The drawings are schematical and not necessarily strictly illustrated. For example, dimensions are not necessarily drawn to scale.

In the specification, a term, such as equal, indicating a relationship between elements, a term, such as a square or a circle, indicating the shape of each element, and a numerical range are not limited to only an expression having strict meaning and also have a substantially equivalent range, for example, with a difference of a few percent.

### First Embodiment

### Whole Configuration

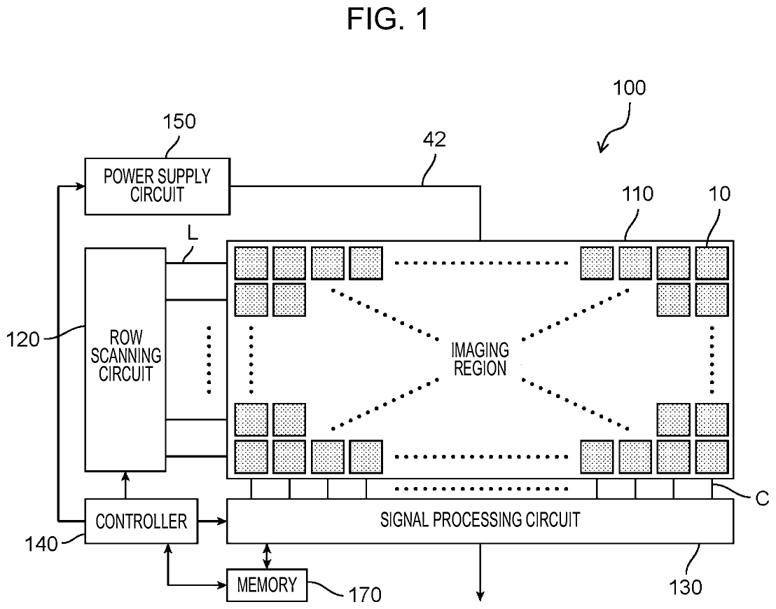

The whole configuration of an imaging device 100 is described below in accordance with FIG. 1. FIG. 1 schematically illustrates the configuration of the imaging device 100 of the first embodiment.

Referring to FIG. 1, the imaging device 100 includes multiple pixels 10 supported on a semiconductor substrate 110, with each pixel 10 including as a portion thereof a photoelectric converter, row control lines L, vertical signal lines C, and a peripheral circuit. The vertical signal line C is an example of a signal line.

The pixels 10 are, for example, two-dimensionally arranged on the semiconductor substrate 110 and thus form an imaging region. The pixels 10 are arranged in a matrix of rows and columns. The arrangement and the number of pixels 10 are not limited to the arrangement and the number of pixels 10 illustrated in FIG. 1 and the pixels 10 may be arranged in any arrangement and in any number. For example, if the pixels 10 are arranged one-dimensionally (in other words, in a single row or a single column), the imaging device 100 may be used as a line sensor.

In the configuration illustrated in FIG. 1, the peripheral circuit includes a row scanning circuit 120, a signal processor 130, a controller 140, a voltage supply circuit 150, and a memory 170. The peripheral circuit may be arranged on the semiconductor substrate 110 or part of the peripheral circuit may be arranged on another substrate.

The row scanning circuit 120 is connected to each pixel 10 via the row control line L. The row control line L is arranged on a per row basis of the pixels 10 and electrically connected to one or more pixels 10 belonging to the same row. Each row control line L is connected to the row scanning circuit 120. Referring to FIG. 1, a single row control line L is illustrated on a per row basis for visibility, but two or more row control lines L may be used on a per row basis as described below. The row scanning circuit 120 selects the pixels 10 on a per row basis by applying a specific voltage to the row control line L and performs a signal output operation, a reset operation, and other operations on the pixels 10.

The signal processor 130 is connected to each pixel 10 via the vertical signal line C. The vertical signal line C is arranged for each column of the pixels 10 and is electrically connected to one or more pixels 10 belonging to the same column. Each of the vertical signal lines C is connected to the signal processor 130. Note that two or more vertical signal lines C may be arranged for the same column.

Each of the pixels 10 selected on a per row basis by the row scanning circuit 120 outputs a signal to the signal processor 130 via the vertical signal line C. The pixel 10 outputs to the vertical signal line C a pixel signal corresponding to signal charges stored on the pixel 10 and a reference signal subsequent to resetting and corresponding to a signal corresponding to a potential after the pixel 10 is reset. The signal processor 130 performs on the signals output from the pixel 10 a variety of signal processing processes, including noise suppression signal processing, such as correlated double sampling, and an analog-to-digital conversion (AD conversion). The signal processor 130 generates image data in accordance with the signals from the pixel 10 and outputs the generated image data. Specifically, the signal processor 130 reads the signals from the pixel 10 as an image signal representing the image data. For example, the signal processor 130 sequentially outputs the image signal on a per reading row basis of the pixels 10. In the specification, the “image signal” is an output signal read in accordance with the signal output via the vertical signal line C and is thus an output signal for use in image forming.

The signal processor 130 may include, for example, a noise suppression signal processing circuit, a sample hold circuit, an analog-to-digital conversion circuit, and a parallel-serial conversion circuit. Also, the signal processor 130 may include a processor.

The controller 140 controls the entire imaging device 100 by receiving instruction data, a clock, and the like supplied from, for example, outside the imaging device 100. For example, the controller 140 includes a timing generator and supplies a driving signal to the row scanning circuit 120, the signal processor 130, the voltage supply circuit 150, and the like. The controller 140 may include a processor.

The voltage supply circuit 150, for example, connected to a bias control line 42, is thus electrically connected to each pixel 10. The voltage supply circuit 150 supplies to each pixel 10 via the bias control line 42 a specific voltage when the imaging device 100 is in operation.

The voltage supply circuit 150 is configured to supply to the bias control line 42 a voltage that is changed from one to another among at least two different voltages. The change of voltage output from the voltage supply circuit 150 may be performed in a stepwise fashion or a continuous fashion. The voltage supply circuit 150 is not limited to a specific voltage supply circuit and may be a circuit that converts a voltage supplied from a power supply, such as a battery, a circuit that outputs a voltage from one of multiple power sources, or a circuit that generates a specific voltage. The voltage supply circuit 150 may be part of the row scanning circuit 120.

The memory 170 is a frame memory that stores a signal corresponding to the signals output from the pixel 10. For example, the memory 170 stores a signal corresponding to the reference signal output from the pixel 10. For example, the signal processor 130 causes the memory 170 to temporarily store a signal, such as the reference signal, and generates the image data using the signal stored on the memory 170. The memory 170 may also store a program that is to be executed by the signal processor 130 and the controller 140. When the signal processor 130 does not use the signal stored on the memory 170 in the generation of the image data, the imaging device 100 may be free from including the memory 170.

### Circuit Configuration

The circuit configuration of the imaging device 100 is described below.

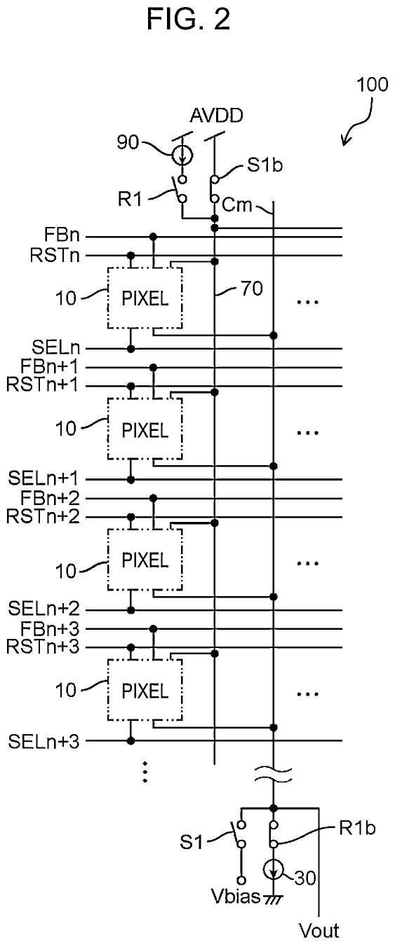

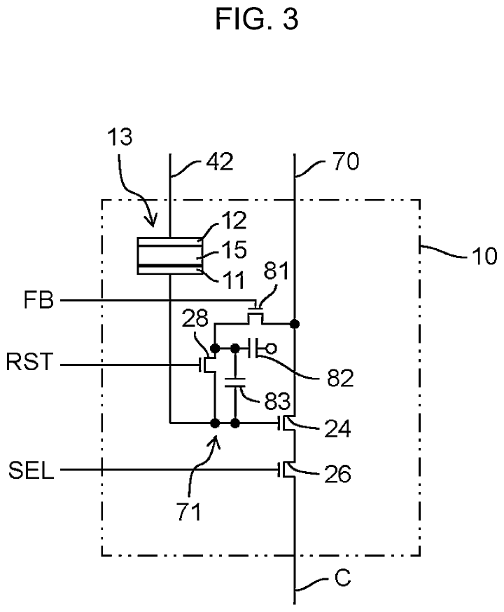

FIG. 2 illustrates the circuit configuration of the imaging device 100. FIG. 3 illustrates the circuit configuration of a pixel 10 in the imaging device 100. FIG. 2 illustrates the circuit configuration of the imaging device 100 focused on the control lines, signal lines, and the like connected to the pixels 10. For this reason, some circuit elements are not illustrated in FIG. 2. FIG. 3 illustrates the circuit configuration within the pixel 10 illustrated in FIG. 2.

Each pixel 10 is connected to a power source line 70. An address control line SEL, a reset control line RST, and a feedback control line FB are arranged for each row of the pixels 10. The address control line SEL, the reset control line RST, and the feedback control line FB correspond to the row control line L. Each of the address control line SEL, the reset control line RST, and the feedback control line FB is electrically connected to one or more pixels 10 belonging to the same row. In FIG. 2, other drawings and the like, described below, characters, such as n and n+1, suffixed to the reference signs of the address control line SEL, the reset control line RST, and the feedback control line FB represent the row of the pixel 10 and n is an integer of 0 or greater, for example, 0 or 1. For example, the address control line SELn represents an address control line SELn connected to the pixels 10 at an n-th row. In FIG. 2 or other drawings, character, such as m, suffixed to the reference sign of the vertical signal line C represents the column of the pixels 10 and m is an integer of 0 or greater, for example, 0 or 1. For example, a vertical signal line Cm represents a vertical signal line C connected to the pixels 10 at the m-th column.

The circuit configuration of the pixels 10 is described below with reference to FIGS. 2 and 3. Each pixel 10 includes a photoelectric converter 13, an amplification transistor 24, an address transistor 26, a reset transistor 28, a bandwidth control transistor 81, a capacitive element 82, and a capacitive element 83.

The photoelectric converter 13 generates a signal in response to incident light. The photoelectric converter 13 is laminated on, for example, on the semiconductor substrate 110. The photoelectric converter 13 is not necessarily a complete single element in each pixel 10 and, for example, may partially straddle multiple pixels 10.

The photoelectric converter 13 in each pixel 10 is connected to the bias control line 42 and is supplied with a specific voltage. As described above, the bias control line 42 is connected to the voltage supply circuit 150.

The amplification transistor 24, the address transistor 26, the reset transistor 28, and the bandwidth control transistor 81 are, for example, field effect transistors (FETs). These transistors herein are N-channel metal oxide semiconductor field effect transistors (MOSFETs). Each of the amplification transistor 24, the address transistor 26, the reset transistor 28, and the bandwidth control transistor 81 includes a control terminal, an input terminal, and an output terminal. The control terminal is, for example, a gate electrode. The input terminal is one of a drain or a source, for example, the drain. The output terminal is the other of the drain and the source, for example, the source.

The control terminal serving as the gate electrode of the amplification transistor 24 is connected to the photoelectric converter 13. In the pixel 10, signal charges generated by the photoelectric converter 13 are accumulated in a charge accumulator 71 between the gate electrode of the amplification transistor 24 and the photoelectric converter 13.

The signal charges herein are holes or electrons. The charge accumulator 71 includes, for example, a node connected to the gate electrode of the amplification transistor 24. The charge accumulator 71 is also referred to as a “floating diffusion node.” The structure of the photoelectric converter 13 is described in detail below.

The input terminal of the amplification transistor 24 is connected to the power source line 70. The power source line 70 is connected to a switch S1b and a switch R1. The switch S1b controls whether the power source line 70 is to be connected to an analog power source AVDD. The switch R1 controls whether the power source line 70 is to be connected to a constant current source 90 into which a current flows from the analog power source AVDD. The output terminal of the amplification transistor 24 is connected to the input terminal of the address transistor 26.

The output terminal of the address transistor 26 is connected to the vertical signal line C. The vertical signal line C is connected to a switch R1b, a switch S1, and the signal processor 130 (see FIG. 1). The switch R1b controls whether the vertical signal line C is to be connected to the constant current source 30 that is connected to analog ground. The switch S1 controls whether the vertical signal line C is to be connected to a voltage Vbias. The switch R1b, the switch S1, and the constant current source 30 are arranged on each column of the pixels 10.

The switch S1b, the switch R1, the switch R1b, and the switch S1 are field effect transistors. The switch S1b, the switch R1, the switch R1b, and the switch S1 are controlled in operation, for example, by the controller 140.

The power source line 70 operates as a source follower power source with the switch S1 off, the switch S1b on, the switch R1 off and the switch R1b on. The amplification transistor 24 amplifies a potential of the charge accumulator 71 and outputs the amplified potential. A signal Vout as a source follower output corresponding to the potential of the gate of the amplification transistor 24 is output as a pixel signal or a reference signal to the signal processor 130 via the vertical signal line C.

The output terminal of the amplification transistor 24 is connected to the input terminal of the address transistor 26. The output terminal of the address transistor 26 is connected to the vertical signal line C. The control terminal of the address transistor 26 is connected to the address control line SEL. Controlling of the potential of the address control line SEL causes the amplification transistors 24 in the pixels 10 to selectively provide an output to the vertical signal line C.

The address control line SEL is connected to the row scanning circuit 120 (see FIG. 1). The row scanning circuit 120 selects on a per row basis the pixels 10 arranged on the rows by applying a specific voltage to the address control line SEL. In this way, the selected pixels 10 output signals.

The reset transistor 28 is connected between the bandwidth control transistor 81 and the charge accumulator 71. The control terminal of the reset transistor 28 is connected to the reset control line RST. Controlling of the potential of the reset control line RST may reset the potential of the charge accumulator 71 in the pixel 10.

The bandwidth control transistor 81 is connected between the power source line 70 and the reset transistor 28 and forms an in-pixel feedback amplifier during resetting. The input terminal of the bandwidth control transistor 81 is connected to the power source line 70. The output terminal of the bandwidth control transistor 81 is connected to the input terminal of the reset transistor 28, one end of the capacitive element 82 and one end of the capacitive element 83. The feedback control line FB is connected to the control terminal of the bandwidth control transistor 81 and the row scanning circuit 120 (see FIG. 1). The potential of the feedback control line FB determines the state of the bandwidth control transistor 81. For example, controlling of the potential of the feedback control line FB causes the charge accumulator 71, the amplification transistor 24, and the bandwidth control transistor 81 to form a feedback loop. In order to negatively feed back the potential of the charge accumulator 71 in this way, reset noise generated with the reset transistor 28 turned off is negatively fed back to the charge accumulator 71. Specifically, the pixel 10 includes a feedback circuit used to negatively feed back the reset noise.

When the potential of the charge accumulator 71 is reset in the in-pixel feedback amplifier, the capacitive element 82 and the capacitive element 83 operate as negative feedback capacitances and thus reduce the reset noise when the potential of the charge accumulator 71 is reset. The one end of the capacitive element 82 is connected to the one end of the capacitive element 83, the input terminal of the reset transistor 28, and the output terminal of the bandwidth control transistor 81. The other end of the capacitive element 82 is supplied, for example, with a reference voltage VR. The one end of the capacitive element 83 is connected to the one end of the capacitive element 82, the input terminal of the reset transistor 28, and the output terminal of the bandwidth control transistor 81. The other end of the capacitive element 83 is connected to the control terminal of the amplification transistor 24 and the output terminal of the reset transistor 28. Each of the capacitive element 82 and the capacitive element 83 is, for example, a metal insulator metal (MIM) capacitance or a metal insulator semiconductor (MIS) capacitance.

The photoelectric converter 13 includes a pixel electrode 11, a counter electrode 12, and a photoelectric conversion layer 15 arranged between the pixel electrode 11 and the counter electrode 12. The pixel electrode 11, the photoelectric conversion layer 15, and the counter electrode 12 are laminated in this order, for example, on the semiconductor substrate 110. The photoelectric converter 13 may further include an electric block layer, a hole block layer, and other elements.

The counter electrode 12 and the photoelectric conversion layer 15 are, for example, formed to straddle multiple pixels 10. The pixel electrode 11 is arranged on each pixel 10. The pixel electrode 11 is electrically isolated from the pixel electrode 11 in another pixel 10. Note that at least one of the counter electrode 12 or the photoelectric conversion layer 15 may be arranged on each pixel 10 or on every multiple pixels 10.

The pixel electrode 11 is electrically connected to the photoelectric conversion layer 15 and serves as an electrode used to collect signal charges generated in the photoelectric conversion layer 15. The pixel electrode 11 is connected to the charge accumulator 71. The pixel electrode 11 is manufactured of an electrically conductive material. The signal charges collected by the pixel electrode 11 are accumulated in the charge accumulator 71.

The counter electrode 12 is a transparent electrode manufactured of an electrically conductive transparent material. The counter electrode 12 is arranged on a light-incident side of the photoelectric conversion layer 15. The counter electrode 12 is connected to the voltage supply circuit 150 illustrated in FIG. 1 via the bias control line 42. When the voltage supply circuit 150 controls the potential of the counter electrode 12 with respect to the potential of the pixel electrode 11, the pixel electrode 11 may collect as signal charges either holes or electrons of hole-electron pairs that are generated in the photoelectric conversion layer 15 through photoelectric conversion. If holes are used as signal charges, the pixel electrode 11 may selectively collect holes by setting the counter electrode 12 to be higher in potential than the pixel electrode 11. Note that the pixel electrode 11 may selectively collect electrons by setting the counter electrode 12 to be lower in potential than the pixel electrode 11.

The photoelectric conversion layer 15 absorbs photons and generates photo charges serving as signal charges. Specifically, the photoelectric conversion layer 15 generates hole-electron pairs in response to incident light. The signal charges are either holes or electrons. If holes are used as signal charges, the pixel electrode 11 may collect holes. The counter electrode 12 collects electrons as charges opposite to the signal charges. The photoelectric conversion layer 15 is manufactured of a photoelectric conversion material, for example, an organic semiconductor material. The photoelectric conversion layer 15 may be manufactured of an inorganic semiconductor material.

The circuit configuration of the pixel 10 is not limited to the example described with reference to FIGS. 2 and 3 but may be one of a variety of circuit configurations of the pixel in the imaging device described with reference to Japanese Unexamined Patent Application Publication No. 2016-127593.

### Operation of Imaging Device

Operation (driving method) of the imaging device 100 in the first embodiment is described below. The following discussion focuses on a reading sequence of image data (image signal). The controller 140 controls driving of the circuit of each pixel 10.

### (1) Operation Example 1

Operation example 1 of the imaging device 100 is described first.

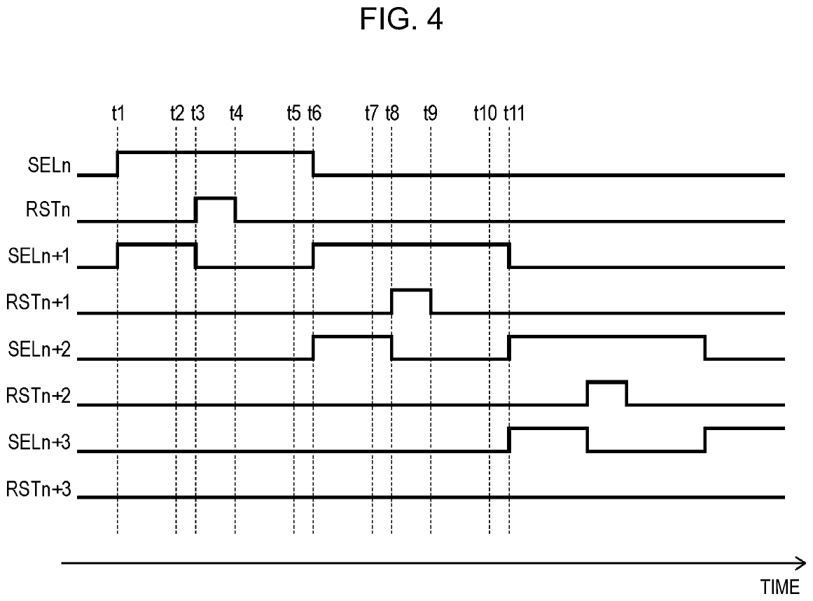

FIG. 4 illustrates a timing chart of the operation example 1 of the imaging device 100. FIG. 4 illustrates variations in the potentials of the address control line SEL and the reset control line RST at multiple rows of the pixels 10 from n-th row to (n+3)-th row. The address transistor 26 is conductive when the potential of the address control line SEL is at a high level and is non-conductive when the potential of the address control line SEL is at a low level. The reset transistor 28 is conductive when the potential of the reset control line RST is at a high level and non-conductive when the potential of the reset control line RST is at a low level.

The discussion of the operation example 1 describes the operation of each pixel 10 at the m-th column and the peripheral circuit corresponding to the pixel 10 and each pixel 10 at the other columns performs an operation that is the same or similar to the operation described above. In the operation examples described below, the m-th column of the pixels 10 is an example of a first column. An n-th row of the pixels 10 is an example of a first row. An (n+1)-th row of the pixels 10 is an example of a second row different from the first row. The pixels 10 at the n-th row and the m-th column are an example of a first pixel. The pixels 10 at the (n+1)-th row and the m-th column are an example of a second pixel.

As described below, the case of obtaining a monochrome image is described for convenience of explanation. When a color image is obtained, a pixel different in color from the pixels 10 may be present between the pixels 10 in a column direction and a row direction. Specifically, when a color image is obtained in the first embodiment, the pixels 10 support the same color and do not include pixels supporting different colors. For this reason, the operation described below is performed on the pixels 10 supporting the same color.

The pixels 10 are exposed first to light before time t1 and signal charges generated by the photoelectric converter 13 are accumulated in the charge accumulator 71 in each pixel 10. The pixels 10 are exposed to light in a global shutter method. For example, if holes are used as signal charges, the voltage supply circuit 150 supplies the counter electrode 12 with a first voltage during an exposure period that sets the counter electrode 12 to be sufficiently lower in potential than the pixel electrode 11. In each pixel 10 in this way, holes as the signal charges generated in the photoelectric conversion layer 15 through photoelectric conversion move to the pixel electrode 11 and accumulated in the charge accumulator 71. As a result, the charge accumulator 71 accumulates the signal charges corresponding to an amount of light incident on the photoelectric converter 13 during the exposure period. After the exposure period, the voltage supply circuit 150 supplies the counter electrode 12 with a second voltage that causes the signal charges not to substantially move in the photoelectric converter 13. Specifically, the voltage supply circuit 150 supplies the counter electrode 12 with the second voltage that sets a voltage difference between the pixel electrode 11 and the counter electrode 12 to be smaller than when the first voltage is supplied, for example, the power supply circuit 150 supplies the counter electrode 12 with the second voltage that sets the voltage difference closer to zero (for example, 1 V or lower). In this way, when light is incident on the photoelectric converter 13, the pixel electrode 11 does not collect the generated signal charges and the charge accumulator 71 holds an amount of signal charges collected during the exposure period. After the exposure period, each pixel 10 successively outputs the pixel signals as described below.

The pixels 10 may be exposed light in a rolling shutter method. In the exposure in the rolling shutter method, the counter electrode 12 is supplied with the first voltage even after the exposure in the same way as in the exposure and a period from when the pixel 10 is reset to when the first pixel signal is output is an exposure period. In order to adjust the exposure period, the pixel 10 may be reset again after resetting immediately before outputting the reference signal.

At time t1, the potential of the address control line SELn rises to a high level, causing the address transistor 26 in each pixel 10 at the n-th row be conductive. The pixel 10 at the n-th row thus transitions to a selected state. The switch S1 is turned off, the switch S1b is turned on, the switch R1 is turned off and the switch R1b is turned on. In this way, the pixel signal corresponding to the amount of signal charges accumulated in the charge accumulator 71 in the pixel 10 at the n-th row is output to the vertical signal line Cm.

At time t1 as well, the potential of the address control line SELn+1 rises to a high level, causing the address transistor 26 in each pixel 10 at the (n+1)-th row to be conductive. Each pixel 10 at the (n+1)-th row thus transitions to a selected state. The pixel signal corresponding to the amount of signal charges accumulated in the charge accumulator 71 in the pixel 10 at the (n+1)-th row is thus output to the vertical signal line Cm. The pixel signal output by each pixel 10 at the n-th row and the pixel signal output by each pixel 10 at the (n+1)-th row are thus mixed in the vertical signal line Cm.

At time t2 when the amplitude of the potential of the vertical signal line Cm corresponding to the output pixel signals is substantially stabilized, the signal processor 130 reads the pixel signal output to the vertical signal line Cm. The signal processor 130 temporarily holds, for example, a voltage level corresponding to the pixel signal output to the vertical signal line Cm. The signal processor 130 may include a capacitive element holding the voltage level. In this case, the pixel signal read by the signal processor 130 is denoted by Sn_n+1.

At time t3, the potential of the reset control line RSTn rises to a high level, causing the reset transistor 28 in each pixel 10 at the n-th row to be conductive. The potential of the feedback control line FBn also rises to a high level, causing the bandwidth control transistor 81 to be conductive. The switch S1 is turned on, the switch S1b is turned off, the switch R1 is turned on, and the switch R1b is turned off. As a result, a source-grounded amplifier including the amplification transistor 24, the vertical signal line Cm, the power source line 70, and the constant current source 90 connected to the power source line 70 is formed in the pixel 10 the n-th row. The pixels 10 at the n-th row are thus reset. Specifically, the potential of the charge accumulator 71 in each pixel 10 at the n-th row is reset to the voltage Vbias.

At time t3 as well, the potential of the address control line SELn+1 falls to a low level, causing the address transistor 26 in each pixel 10 at the (n+1)-th row to be non-conductive. Each pixel 10 at the (n+1)-th row thus transitions to an unselected state. The potential of the reset control line RSTn+1 remains at a low level. For this reason, the pixels 10 at the (n+1)-th row are not reset.

At time t4, the potential of the reset control line RSTn falls to a low level, causing the reset transistor 28 in each pixel 10 at the n-th row to be non-conductive. In this case, the potential of the feedback control line FBn is at an intermediate level between a high level and a low level and the bandwidth control transistor 81 operates as a resistance circuit, thereby forming a negative feedback amplifier. After that, at a specific time point between time t4 and time t5, the potential of the feedback control line FBn falls to a low level, causing the bandwidth control transistor 81 to be non-conductive, and completing the resetting of the potential of the charge accumulator 71. The switch S1 is turned off, the switch S1b is turned on, the switch R1 is turned off, and the switch R1b is turned on. The reference signal after the resetting of the pixel 10 at the n-th row, namely, the reference signal corresponding to the potential of the charge accumulator 71 is output to the vertical signal line Cm. The pixel 10 at the n-th row is reset after outputting the pixel signal and then outputs the reference signal after the resetting. In this case, the signal of the pixel 10 at the (n+1)-th row is not output to the vertical signal line Cm. Specifically, only the reference signal of the pixel 10 at the n-th row is output to the vertical signal line Cm.

The resetting operation using a feedback amplifier configuration described above may reduce the reset noise that is attributed to the reset transistor 28 and generated when the potential of the charge accumulator 71 is reset. Note that the potential of the feedback control line FBn transitioning at time t4 to a low level rather than to the intermediate level between the high level and the low level may complete the resetting of the pixel 10. Also note that the resetting is complete at time t4 if the configuration of the pixel 10 does not include the feedback circuit.

At time t5, the signal processor 130 reads the reference signal output to the vertical signal line Cm. The reference signal read by the signal processor 130 is denoted by Rn. The signal processor 130 generates the image signal at each pixel 10 at the n-th row. The image signal of the pixel 10 at the n-th row is obtained as a difference signal (Sn_n+1−Rn) between the pixel signal Sn_n+1 and the reference signal Rn. The signal processor 130 obtains the difference signal as an output voltage difference between a voltage corresponding to the pixel signal Sn_n+1 and a voltage corresponding to the reference signal Rn.

At time t6, the potential of the address control line SELn falls to a low level, causing the address transistor 26 in each pixel 10 at the n-th row to be non-conductive. The pixel 10 at the n-th row thus transitions to an unselected state.

At time t6 as well, the potential of the address control line SELn+1 rises to a high level, causing the address transistor 26 in each pixel 10 at the (n+1)-th row. The pixel 10 at the (n+1)-th row thus transitions to a selected state. The switch S1 is turned off, the switch S1b is turned on, the switch R1 is turned off, and the switch R1b is turned on. In this way, the pixel signal corresponding to the amount of signal charges accumulated in the charge accumulator 71 in the pixel 10 at the (n+1)-th row is output to the vertical signal line Cm. Since the pixel signal of the pixel 10 at the (n+1)-th row is output in a non- destructive fashion from time t1 to time t3, the pixel 10 at the (n+1)-th row is not reset. For this reason, the pixel 10 at the (n+1)-th row is able to output the pixel signal again. Since the voltage supply circuit 150 supplies the counter electrode 12 with the second voltage that causes the charge accumulator 71 not to substantially accumulate signal charges, the output value of the pixel signal of the pixel 10 at the (n+1)-th row remains unchanged through time elapse.

At time t6 as well, the potential of the address control line SELn+2 rises to a high level, also causing the address transistor 26 in each pixel 10 at the (n+2)-th row to be conductive. The pixel 10 at the (n+2)-th row thus transitions to a selected state. The pixel signal corresponding to the amount of signal charges accumulated in the charge accumulator 71 in the pixel 10 at the (n+2)-th row is thus output to the vertical signal line Cm. The pixel signal output by the pixel 10 at the (n+1)-th row and the pixel signal output by the pixel 10 at the (n+2)-th row are thus mixed in the vertical signal line Cm.

At time t7 when the amplitude of the potential of the vertical signal line Cm corresponding to the output pixel signals is substantially stabilized, the signal processor 130 reads the pixel signal output to the vertical signal line Cm. In this case, the pixel signal read by the signal processor 130 is denoted by Sn+1_n+2.

At time t8, the potential of the reset control line RSTn+1 rises to a high level, causing the reset transistor 28 in each pixel 10 at the (n+1)-th row to be conductive. In this case, the feedback control line FBn+1 also rises to a high level, causing the bandwidth control transistor 81 to be conductive. The switch S1 is turned on, the switch S1b is turned off, the switch R1 is turned on, and the switch R1b is turned off. The pixel 10 at the (n+1)-th row is thus reset. Specifically, the potential of the charge accumulator 71 in the pixel 10 at the (n+1)-th row is thus reset to the voltage Vbias.

At time t8 as well, the potential of the address control line SELn+2 falls to a low level, causing the address transistor 26 in each pixel 10 at the (n+2)-th row to be non-conductive. The pixel 10 at the (n+2)-th row thus transitions to an unselected state. The potential of the reset control line RSTn+2 remains at a low level. The pixel 10 at the (n+2)-th row is not reset.

At time t9, the potential of the reset control line RSTn+1 falls to a low level, causing the reset transistor 28 in each pixel 10 at the (n+1)-th row to be non-conductive. In this case, the potential of the feedback control line FBn+1 transitions to an intermediate level between a high level and a low level and the bandwidth control transistor 81 operates as a resistance circuit, forming a negative feedback amplifier. After that, at a specific time point between time t9 and time t10, the potential of the feedback control line FBn+1 falls to a low level, causing the bandwidth control transistor 81 to be non-conductive, and completing the resetting of the potential of the charge accumulator 71. The switch S1 is turned off, the switch S1b is turned on, the switch R1 is turned off, and the switch R1b is turned on. The reference signal after the resetting of the pixels 10 at the (n+1)-th row is thus output to the vertical signal line Cm. In this case, the signal in the pixel 10 at the (n+2)-th row is not output to the vertical signal line Cm. In other words, only the reference signal of the pixel 10 at the (n+1)-th row is output to the vertical signal line Cm.

At time t10, the signal processor 130 reads the reference signal output to the vertical signal line Cm. The reference signal read by the signal processor 130 is denoted by Rn+1. The signal processor 130 generates the image signal at the pixel 10 at the (n+1)-th row. The image signal of the pixel 10 at the (n+1)-th row is obtained as a difference signal (Sn+1_n+2−Rn+1) between the pixel signal Sn+1_n+2 and the reference signal Rn+1.

At time t11, the potential of the address control line SELn+1 falls to a low level, causing the address transistor 26 in each pixel 10 at the (n+1)-th row to be non-conductive. the pixel 10 at the (n+1)-th row thus transitions to a selected state.

At time t11 as well, the potential of the address control line SELn+2 rises to a high level, causing the address transistor 26 in each pixel 10 at the (n+2)-th row to be conductive. The pixel 10 at the (n+2)-th row thus transitions to a selected state. Hereinafter, operations that are the same as or similar to the operations performed at the n-th row and the (n+1)-th row are performed on the pixels 10 at each of the (n+2)-th and subsequent rows. In this way, the signal processor 130 outputs the image signals of the pixels at the same number of rows as the number of rows of the pixels 10.

In the operation example 1 as described above, the pixels 10 successively output the pixel signal and the reference signal to the vertical signal line Cm on a per reading row basis of the pixels 10. During the first period (from time t1 to time t3) while each pixel 10 at the n-th row as a reading row outputs the pixel signal, each pixel 10 at the (n+1)-th row serving as the next reading row subsequent to the n-th row also outputs the pixel signal. During the second period (from a specific time point between time t4 and time t5 to time t6) while the pixel 10 at the n-th row outputs the reference signal, the pixel 10 at the (n+1)-th row does not output the reference signal. The pixel 10 at the (n+1)-th row re-outputs the pixel signal before the resetting after the first period. The signal processor 130 generates the image data in accordance with the pixel signal Sn_n+1 which the pixel 10 at the n-th row and the pixel 10 at the (n+1)-th row have output to the vertical signal line Cm during the first period and in accordance with the reference signal Rn which the pixel 10 at the n-th row has output to the vertical signal line Cm.

In the operation as described above, the pixel signals of the pixels 10 at two rows are output to the vertical signal line Cm and thus mixed. If the values of the pixel signals of the pixels 10 at the two rows are almost equal, the effective gate width of the amplification transistor 24 is doubled and thus the mutual conductance gm of the amplification transistor 24 is multiplied by √2. Generally, random noise generated by the amplification transistor 24 is proportional to 1/gm. Noise reduction characteristics may be realized by causing the pixel signals of the pixels 10 at the two rows to be output to the vertical signal line Cm. Generally, settling time is also proportional to 1/gm. High-speed driving may thus be realized by causing the pixel signals of the pixels 10 at the two rows to be output to the vertical signal line Cm. For example, a time period from time t1 to time t2 may be set to be shorter.

Unlike in the case of Japanese Unexamined Patent Application Publication No. 2010-259027 where the image signal is read on a two-rows-at-time basis, the image signal is read on a per one-reading row basis in the operation example 1. For this reason, if the pixel signals of the pixels 10 at the two rows are concurrently output to the vertical signal line Cm, resolution may be free from deterioration and a higher resolution image may result. The imaging device 100 may thus efficiently realize noise reduction characteristics.

In the specification, the “reading row” is different in concept from a row of the pixels 10 that outputs a signal but is a row of the pixels 10 that serves as a target from which the signal processor 130 reads a signal as an image signal. Specifically, the reading row of the pixels 10 has a one-to-one correspondence with a row of pixels of the image signal (the image data) output by the signal processor 130. In the first embodiment, the effect described above may be obtained by causing the pixels 10 at a reading row and the pixels 10 at a row different from the reading row to concurrently output the pixel signals. If the color image is obtained, a “next reading row” is a next reading row of the pixels 10 of the same color.

### (2) Operation Example 2

Operation example 2 of the imaging device 100 is described below. The following discussion of the operation example 2 focuses on the difference between the operation example 1 and the operation example 2 and the common portion therebetween is briefly described or not described at all. In the operation example 2, the signal processor 130 generates the image signal using the reference signal stored on the memory 170.

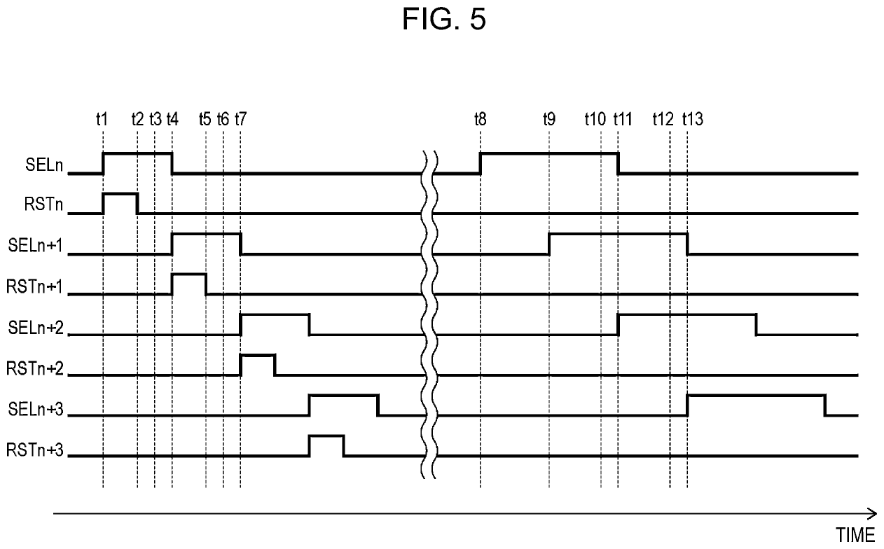

FIG. 5 is a timing chart of the operation example 2 of the imaging device 100. FIG. 5 illustrates the same timing chart items as FIG. 4. The following discussion of the operation example 2 focuses on the operation of the pixel 10 at an m-th column and a peripheral circuit corresponding to the pixel 10 at the m-th column and operations that are the same or similar to the operations described above are performed on the pixels 10 at the other columns.

At time t1, the potential of the address control line SELn rises to a high level, causing the address transistor 26 in each pixel 10 at the n-th row to be conductive. The potential of the reset control line RSTn rises to a high level, causing the reset transistor 28 in the pixel 10 at the n-th row to be conductive. The potential of the feedback control line FBn also rises to a high level, causing the bandwidth control transistor 81 to be conductive. The switch S1 is turned on, the switch S1b is turned off, the switch R1 is turned on, and the switch R1b is turned off. The pixels 10 at the n-th row are thus reset.

At time t2, the potential of the reset control line RSTn falls to a low level, causing the reset transistor 28 in each pixel 10 at the n-th row to be non-conductive. In this case, the potential of the feedback control line FBn transitions to an intermediate potential between a high level and a low level. After that, at a specific time point between time t2 and time t3, the potential of the feedback control line FBn falls to a low level, causing the bandwidth control transistor 81 to be non-conductive and completing the resetting of the potential of the charge accumulator 71. The switch S1 is turned off, the switch S1b is turned on, the switch R1 is turned off, and the switch R1b is turned on. The pixel 10 at the n-th row after being reset thus outputs the reference signal to the vertical signal line Cm. The signal of the pixel 10 at the (n+1)-th row is not output to the vertical signal line Cm. Specifically, only the reference signal of the pixel 10 at the n-th row is output to the vertical signal line Cm.

At time t3, the signal processor 130 reads the reference signal output to the vertical signal line Cm. The reference signal read by the signal processor 130 is denoted by Rn. The signal processor 130 causes the memory 170 to store the read reference signal Rn. For example, the signal processor 130 causes the memory 170 to store a digital value into which the reference signal Rn is converted.

At time t4, the potential of the address control line SELn falls to a low level, causing the address transistor 26 in each pixel 10 at the n-th row to be non-conductive.

At time t4 as well, the potential of the address control line SELn+1 rises to a high level, causing the address transistor 26 in each pixel 10 at the (n+1)-th row to be conductive. Also, the potential of the reset control line RSTn+1 rises to a high level, causing the reset transistor 28 in each pixel 10 at the (n+1)-th row to be conductive. In this case, the potential of the feedback control line FBn+1 rises to a high level, causing the bandwidth control transistor 81 to be conductive. The switch S1 is turned on, the switch S1b is turned off, the switch R1 is turned on, and the switch R1b is turned off. The pixel 10 at the (n+1)-th row is thus reset.

At time t5, the potential of the reset control line RSTn+1 falls to a low level, causing the reset transistor 28 in each pixel 10 at the (n+1)-th row to be non-conductive. The potential of the feedback control line FBn+1 transitions to an intermediate level between a high level and a low level. After that, at a specific time point between time t5 and time t6, the potential of the feedback control line FBn+1 falls to a low level, causing the bandwidth control transistor 81 to be non-conductive and completing the resetting of the potential of the charge accumulator 71. The switch S1 is turned off, the switch S1b is turned on, the switch R1 is turned off, and the switch R1b is turned on. In this way, the pixel 10 at the (n+1)-th row after being reset outputs the reference signal to the vertical signal line Cm. In this case, the signal of the pixel 10 at the (n+2)-th row is not output to the vertical signal line Cm. Specifically, only the reference signal of the pixel 10 at the (n+1)-th row is output to the vertical signal line Cm.

At time t6, the signal processor 130 reads the reference signal output to the vertical signal line Cm. The reference signal read by the signal processor 130 is denoted by Rn+1. The signal processor 130 causes the memory 170 to store the read reference signal Rn+1. For example, the signal processor 130 causes the memory 170 to store a digital value into which the reference signal Rn+1 is AD converted.

At time t7, the potential of the address control line SELn+1 falls to a low level, causing the address transistor 26 in each pixel 10 at the (n+1)-th row to be non-conductive. At time t7 and thereafter, operations that are the same as or similar to the operations performed on the pixels 10 at the n-th and (n+1)-th rows and include resetting the pixels 10 and reading the reference signals from the pixels 10 are performed on the pixels 10 at each of the (n+2)-th and subsequent rows.

After all the pixels 10 are reset, the pixels 10 are exposed to light during a specific period in a time period until time t8. The exposure operation has been described with reference to the operation example 1.

At time t8, the potential of the address control line SELn rises to a high level, causing the address transistor 26 in each pixel 10 at the n-th row to be conductive. The switch S1 is turned off, the switch S1b is turned on, the switch R1 is turned off, and the switch R1b is turned on. The pixel signal corresponding to the amount of signal charges accumulated in the charge accumulator 71 in the pixel 10 at the n-th row is output to the vertical signal line Cm.

At time t9, the potential of the address control line SELn+1 rises to a high level, causing the address transistor 26 in each pixel 10 at the (n+1)-th row to be conductive. The pixel signal corresponding to the amount of signal charges accumulated in the charge accumulator 71 in the pixel 10 at the (n+1)-th row is thus output to the vertical signal line Cm. As a result, the pixel signal output by the pixel 10 at the n-th row and the pixel signal output by the pixel 10 at the (n+1)-th row are thus mixed in the vertical signal line Cm.

At time t10, the signal processor 130 reads the pixel signal output to the vertical signal line Cm. The pixel signal read by the signal processor 130 is denoted by Sn_n+1. The signal processor 130 generates the image signal at the pixel 10 at the n-th row. The image signal of the pixel 10 at the n-th row is obtained as a difference signal between the pixel signal Sn_n+1 and a mean value of the reference signal Rn and the reference signal Rn+1. For example, the signal processor 130 obtains the image signal of the pixel 10 at the n-th row by referencing, after AD converting the read pixel signal Sn_n+1, the reference signal Rn and the reference signal Rn+1 stored on the memory 170 and by subtracting from the pixel signal Sn_n+1 the mean value of the reference signal Rn and the reference signal Rn+1.

At time t11, the potential of the address control line SELn falls to a low level, causing the address transistor 26 in each pixel 10 at the n-th row to be non-conductive. The potential of the address control line SELn+1 remains at a high level and the address transistor 26 in the pixel 10 at the (n+1)-th row remains conductive. At time t11 as well, the pixel signal of the pixel 10 at the (n+1)-th row is thus output to the vertical signal line Cm.

At time t11 as well, the potential of the address control line SELn+2 rises to a high level, causing the address transistor 26 in each pixel 10 at the (n+2)-th row to be conductive. The pixel signal corresponding to the amount of signal charges accumulated in the charge accumulator 71 in the pixel 10 at the (n+2)-th row is thus output to the vertical signal line Cm. As a result, the pixel signal output by the pixel 10 at the (n+1)-th row and the pixel signal output by the pixel 10 at the (n+2)-th row are thus mixed in the vertical signal line Cm.

At time t12, the signal processor 130 reads the pixel signal output to the vertical signal line Cm. The pixel signal read by the signal processor 130 is denoted by Sn+1_n+2. The signal processor 130 generates the image signal of the pixel 10 at the (n+1)-th row. The image signal of the pixel 10 at the (n+1)-th row is obtained as a difference signal between the pixel signal Sn+1_n+2 and a mean value of the reference signal Rn+1 and the reference signal Rn+2. For example, the signal processor 130 obtains the image signal of the pixel 10 at the (n+1)-th row by referencing, after AD converting the read pixel signal Sn+1_n+2, the reference signal Rn+1 and the reference signal Rn+2 of the pixel 10 at the (n+2)-th row stored on the memory 170 and by subtracting from the pixel signal Sn+1_n+2 the mean value of the reference signal Rn+1 and the reference signal Rn+2.

At time t13, the potential of the address control line SELn+1 falls to a low level, causing the address transistor 26 in each pixel 10 at the (n+1)-th row to be non-conductive. At time t13 as well, the potential of the address control line SELn+3 rises to a high level, causing the address transistor 26 in each pixel 10 at an (n+3)-th row to be conductive. At time t13 and thereafter, operations that are the same as or similar to the operations performed at the n-th and (n+1)-th rows and include reading the pixel signals and generating the image signals are performed at each of the (n+2)-th and subsequent rows of the pixels 10.

In the operation example 2 in this way, the signal processor 130 generates the image data in accordance with the reference signal Rn that the pixel 10 at the n-th row has output to the vertical signal line Cm, the reference signal Rn+1 that the pixel 10 at the (n+1)-th row has output to the vertical signal line Cm, and the pixel signal Sn_n+1 that the pixels 10 at the n-th and the (n+1)-th rows have output to the vertical signal line Cm for the first period.

In the operation example 2 as in the operation example 1, the pixel signals of the pixels 10 at the two rows output to the vertical signal line Cm may realize noise reduction characteristics and high-speed driving. The signal processor 130 generates the image data using the pixel signal that is a mixture of the reference signals of the pixels 10 at the two rows and the pixel signals of the pixels 10 at the two rows. This causes the reset noise of the pixels 10 at the two rows to be superimposed to each of the reference signals and the pixel signals used to generate the image data. Subtracting the reference signal of the pixels 10 at the two rows from the mixture of pixel signals of the pixels 10 at the two rows may remove the effect of the reset noise and realize further noise reduction characteristics.

When the resetting is performed after the outputting of the pixel signal and the reference signal is then output, the reset noise of the resetting before the outputting of the pixel signal is superimposed on the pixel signal and the reset noise of the resetting after the outputting of the pixel signal is superimposed on the reference signal. In other words, the reset noises in different reset operations are respectively superimposed on the reference signal and the pixel signal. In the operation example 2 in contract, the pixel 10 at the n-th row accumulates signal charges during the exposure period after the outputting of the reference signal subsequent to the resetting and then outputs the pixel signal. In this way, the reset noises in the same resetting operation are respectively superimposed on the reference signal and the pixel signal. For this reason, subtracting the reference signal from the pixel signal may thus accurately remove the effect of the reset noise and realize further noise reduction characteristics.

When the imaging device 100 performs the operation example 2, the effect of the reset noise may be reduced and the imaging device 100 may be free from including the feedback circuit that feeds back the reset noise. In this way, the pixel circuit may be simplified.

Note that the signal processor 130 generates in the operation example 2 the image data using the reference signals of the pixels 10 at the two rows stored on the memory 170, but the signal processor 130 may generate the image data using the reference signals of the pixels 10 at one row (specifically, the pixels 10 at the reading row).

The signal processor 130 may output the AD converted pixel signal and reference signal to the outside without generating the image data and an external processing circuit may cause an external memory to store the output reference signal and generate the image data.

### (3) Operation Example 3

Operation example 3 of the imaging device 100 is described below. The following discussion of the operation example 3 focuses on the difference between the operation example 1 and the operation example 3 and the common portion therebetween is briefly described or not described at all. In the operation example 3 as described below, the pixel signals of the pixels 10 at three rows are concurrently output to the vertical signal line C.

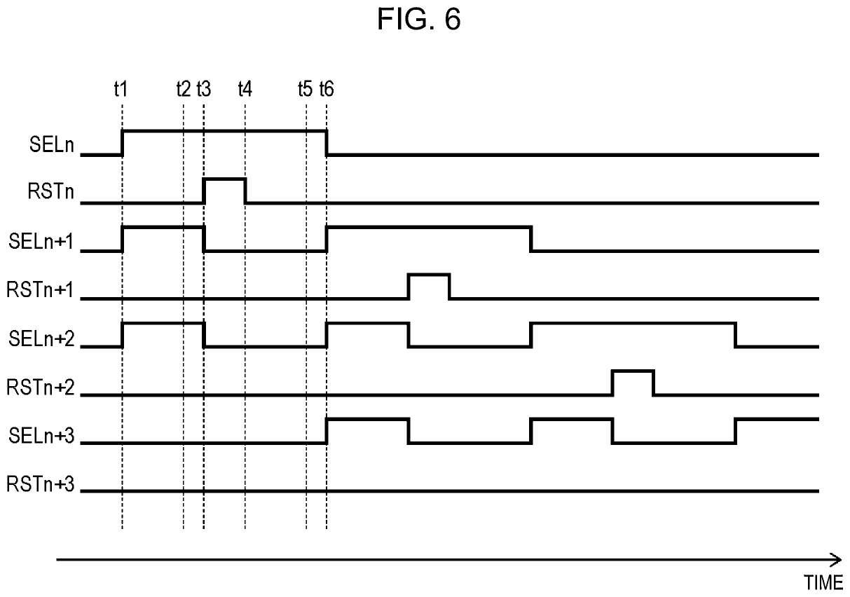

FIG. 6 is a timing chart of the operation example 3 of the imaging device 100. FIG. 6 illustrates the same timing chart items as FIG. 4. The following discussion of the operation example 3 focuses on the operation of each pixel 10 at the m-th column and the peripheral circuit of the pixel 10 at the m-th column and operations that are the same as or similar to the operations described above are performed on the pixels 10 at the other columns. In the operation example 3, the (n+2)-th row of the pixels 10 is an example of a third row different from the first and second rows.

As in a manner as in the operation example 1, the pixels 10 are exposed to light before time t1 and the charge accumulator 71 of each pixel 10 accumulates signal charges generated by the photoelectric converter 13.

At time t1, the potential of the address control line SELn rises to a high level, causing the address transistor 26 in each pixel 10 at the n-th row to be conductive. The switch S1 is turned off, the switch S2b is turned on, the switch R1 is turned off, and the switch R1b is turned on. In this way, the pixel signal corresponding to the amount of signal charges accumulated in the charge accumulator 71 in the pixel 10 at the n-th row is output to the vertical signal line Cm.

At time t1 as well, the potentials of the address control lines SELn+1 and SELn+2 rise to a high level, causing the address transistors 26 in pixels 10 at the (n+1)-th and (n+2)-th rows to be conductive. The pixel signals corresponding to the amounts of signal charges accumulated in the charge accumulators 71 in the pixels 10 at the (n+1)-th and (n+2)-th rows are thus output to the vertical signal line Cm. The pixel signal output by the pixel 10 at the n-th row, the pixel signal output by the pixel 10 at the (n+1)-th row, and the pixel signal output by the pixel 10 at the (n+2)-th row are mixed in the vertical signal line Cm.

At time t2, the signal processor 130 reads the pixel signal output to the vertical signal line Cm. The pixel signal read by the signal processor 130 is denoted by Sn_n+1_n+2.

At time t3, the potential of the reset control line RSTn rises to a high level, causing the reset transistor 28 in each pixel 10 at the n-th row to be conductive. The potential of the feedback control line FBn also rises to a high level, causing the bandwidth control transistor 81 to be conductive. The switch S1 is turned on, the switch S1b is turned off, the switch R1 is turned on, and the switch R1b is turned off. The pixel 10 at the n-th row is reset and the potential of the charge accumulator 71 in the pixel 10 at the n-th row is reset to Vbias.

At time t3 as well, the potentials of the address control lines SELn+1 and SELn+2 fall to a low level, causing the address transistors 26 in pixels 10 at the (n+1)-th and (n+2)-th row to be non-conductive.

From time t3 to time t5, each pixel 10 at the n-th row is reset in an operation that is the same as or similar to the operation example 1. The reference signal of the pixel 10 at the n-th row is thus output to the vertical signal line Cm.

At time t5, the signal processor 130 reads the reference signal output to the vertical signal line Cm. The reference signal read by the signal processor 130 is denoted by Rn. The signal processor 130 generates the image signal at each pixel 10 at the n-th row. The image signal of the pixel 10 at the n-th row is obtained as a difference signal (Sn_n+1_n+2−Rn) between the pixel signal Sn_n+1_n+2 and the reference signal Rn.

At time t6, the potential of the address control line SELn falls to a low level, causing the address transistor 26 in each pixel 10 at the n-th row to be non-conductive. At time t6 as well, the potential of the address control line SELn+1 rises to a high level, causing the address transistor 26 in each pixel 10 at the (n+1)-th row to be conductive. At time t6 as well, the potentials of the address control lines SELn+2 and SELn+3 rise to a high level, causing the address transistors 26 in the pixels 10 at the (n+2)-th and (n+3)-th rows to be conductive. Hereinafter, operations that are the same as or similar to the operations performed at the n-th row are performed on the pixels 10 at each of all of the (n+1)-th and subsequent rows.

In the operation example 3, during the first period (from time t1 to time t3) while each pixel 10 at the n-th row as a reading row outputs the pixel signal, each pixel 10 at the (n+1)-th row subsequent to the n-th row and each pixel 10 at the (n+2)-th row subsequent to the (n+1)-th row output the pixel signals. During the second period (from a specific time point between time t4 and time t5 to time t6) while the pixel 10 at the n-th row outputs the reference signal, each of the pixels 10 at the (n+1)-th and the (n+2)-th rows does not output the reference signal. Each of the pixels 10 at the (n+1)-th and (n+2)-th rows re-outputs the pixel signal before the resetting after the first period.

In the operation described above, the pixel signals of the pixels 10 at three rows are output to the vertical signal line Cm and thus mixed. If the values of the pixel signals of the pixels 10 at the three rows are almost equal, the effective gate width of the amplification transistor 24 is tripled and thus the mutual conductance gm of the amplification transistor 24 is multiplied by √3. Since the pixel signals of the pixels 10 at the three rows are concurrently output to the vertical signal line Cm, further noise reduction characteristics and high-speed driving may be realized.

In the operation example 3 as in the operation example 2, each pixel 10 may store the signal charges during the exposure period after outputting the reference signal and then output the pixel signal.

### (4) Operation Example 4

Operation example 4 of the imaging device 100 is described below. The following discussion of the operation example 4 focuses on the difference between the operation example 1 and the operation example 4 and the common portion therebetween is briefly described or not described at all. In the operation example 4 as described below, the pixel signal and the reference signal are read from the pixels 10 on a two-rows-at-time basis.

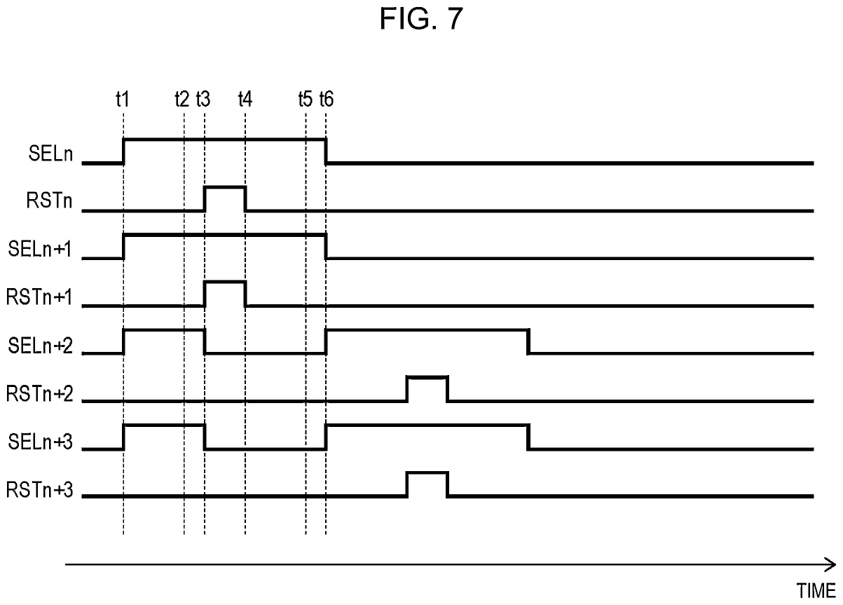

FIG. 7 is a timing chart of the operation example 4 of the imaging device 100. FIG. 7 illustrates the same timing chart items as FIG. 4. The following discussion of the operation example 4 focuses on the operation of each pixel 10 at the m-th column and the peripheral circuit corresponding to the pixel 10 at the m-th column and an operation that is the same as or similar to the operation of the pixel 10 at the m-th column is performed on the pixels 10 at the other columns.

As in a manner as in the operation example 1, the pixels 10 are exposed to light before time t1 and the charge accumulator 71 of each pixel 10 accumulates signal charges generated by the photoelectric converter 13.

At time t1, the potentials of the address control lines SELn and SELn+1 rise to a high level, causing the address transistors 26 in the pixels 10 at the n-th and (n+1)-th rows to be conductive. The switch S1 is turned off, the switch S1b is turned on, the switch R1 is turned off, and the switch R1b is turned on. The pixel signals corresponding to the amounts of signal charges accumulated in the charge accumulators 71 in the pixels 10 at the n-th and (n+1)-th rows are thus output to the vertical signal line Cm.

At time t1 as well, the potentials of the address control lines SELn+2 and SELn+3 rise to a high level, causing the address transistors 26 in the pixels 10 at the (n+2)-th and (n+3)-th rows to be conductive. The pixel signals corresponding to the amounts of signal charges accumulated in the charge accumulators 71 in the pixels 10 at the (n+2)-th and (n+3)-th rows are thus output to the vertical signal line Cm. The pixel signal output by the pixel 10 at the n-th row, the pixel signal output by the pixel 10 at the (n+1)-th row, the pixel signal output by the pixel 10 at the (n+2)-th row, and the pixel signal output by the pixel 10 at the (n+3)-th row are mixed in the vertical signal line Cm.

At time t2, the signal processor 130 reads the pixel signal output to the vertical signal line Cm. The pixel signal read by the signal processor 130 is denoted by Sn_n+1_n+2_n+3.

At time t3, the potentials of the reset control lines RSTn and RSTn+1 rise to a high level, causing the reset transistors 28 in the pixels 10 at the n-th and (n+1)-th rows to be conductive. In this case, the potentials of the feedback control lines FBn and FBn+1 also rise to a high level, causing the bandwidth control transistors 81 to be conductive. The switch S1 is turned on, the switch S1b is turned off, the switch R1 is turned on, and the switch R1b is turned off. In this way, the pixels 10 at the n-th and (n+1)-th rows are reset. The potentials of the charge accumulators 71 in the pixels 10 at the n-th and (n+1)-th rows are thus reset to Vbias.

At time t3 as well, the potentials of the address control lines SELn+2 and SELn+3 fall to a low level, causing the address transistors 26 in the pixels 10 at the (n+2)-th and (n+3)-th row to be non-conductive.

From time t3 to time t5, the pixels 10 at the n-th and (n+1)-th rows are reset in a manner as in the operation example 1. In this way, after the resetting, the reference signals of the pixels 10 at the n-th and (n+1)-th rows are output to the vertical signal line Cm.

At time t5, the signal processor 130 reads the reference signals output to the vertical signal line Cm. The reference signals read by the signal processor 130 is denoted by Rn_n+1. The signal processor 130 generates the image signals of the pixel 10 at the n-th and (n+1)-th rows as two reading rows. The image signals of the pixels 10 at the n-th and (n+1)-th rows are obtained as a difference signal (Sn_n+1_n+2_n+3−Rn_n+1) between the pixel signal Sn_n+1_n+2_n+3 and the reference signal Rn_n+1.

At time t6, the potentials of the address control lines SELn and SELn+1 fall to a low level, causing the address transistors 26 in the pixels 10 at the n-th and (n+1)-th rows to be non-conductive. At time t6 as well, the potentials of the address control line SELn+2 and SELn+3 rise to a high level, causing the address transistors 26 in the pixels 10 at the (n+2)-th and (n+3)-th rows to be conductive. Hereinafter, operations that are the same as or similar to the operations performed at the n-th and (n+1)-th rows are performed on the pixels 10 at the (n+2)-th and subsequent rows on a two-rows-at-time basis of the pixels 10. The signal processor 130 thus outputs the image signals of the pixels at half as many as the number of rows of the pixels 10.

In the operation example 4 described above, the pixel signals of the pixels 10 at four rows are output to the vertical signal line Cm and thus mixed. If the values of the pixel signals of the pixels 10 at the four rows are almost equal, the effective gate width of the amplification transistor 24 is quadrupled and thus the mutual conductance gm of the amplification transistor 24 is multiplied by 2. Although resolution in the operation example 4 is half as high as in the operation example 1, the pixel signals of the pixels 10 at the four rows are concurrently output to the vertical signal line Cm, and thus further noise reduction characteristics and high-speed driving may be realized.

In the operation example 4 as in the operation example 2, each pixel 10 may store the signal charges during the exposure period after outputting the reference signal and then output the pixel signal.

### Second Embodiment

An imaging device 101 in the second embodiment is described below. The discussion of the second embodiment focuses on the difference between the first embodiment and the second embodiment and the common portion therebetween is briefly described or not described at all.

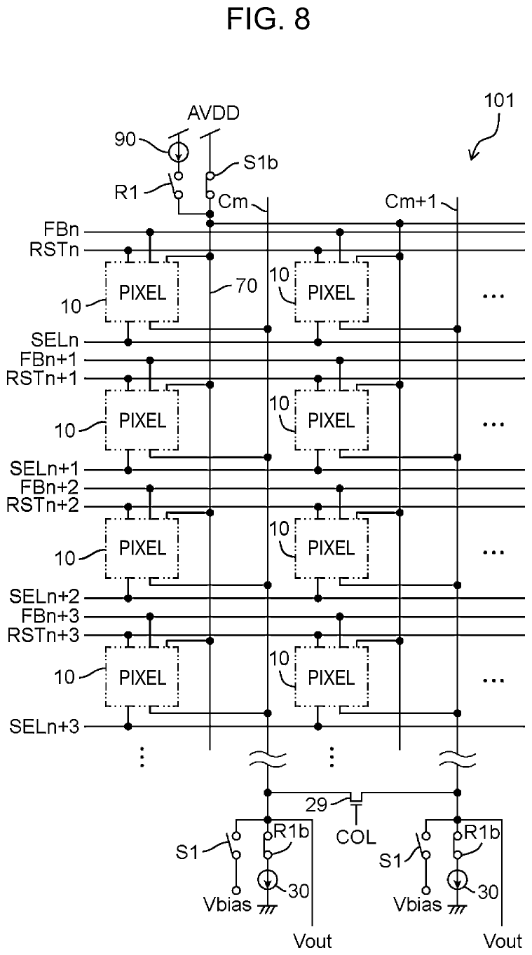

FIG. 8 illustrates a circuit configuration of the imaging device 101 in the second embodiment. The circuit configuration of the imaging device 101 illustrated in FIG. 8 is drawn with a focus on control lines, signal lines, and the like connected to each pixel 10.

Referring to FIG. 8, in comparison with the imaging device 100 in the first embodiment, the imaging device 101 is different in that the imaging device 101 further includes a switch 29 that is connected to mutually adjacent vertical signal lines C.

The switch 29 is arranged between the vertical signal line Cm arranged for each pixel 10 at the m-th column and the vertical signal line Cm+1 arranged for each pixel 10 at the (m+1)-th column adjacent to the m-th column. Specifically, the vertical signal line Cm is connected to one of the two pixels 10 adjacent to each other in a row direction and the vertical signal line Cm+1 is connected to the other of the two pixels. One end of the switch 29 is connected to the vertical signal line Cm and the other end of the switch 29 is connected to the vertical signal line Cm+1. The switch 29 controls whether the vertical signal line Cm and the vertical signal line Cm+1 are to be connected to each other. Each switch 29 is arranged for every two vertical signal lines C that are mutually adjacent and every two vertical signal lines C that are adjacent in the row direction are connected to each other via the switch 29, but this arrangement is not illustrated. The switch 29 is, for example, an field effect transistor. If the imaging device 101 further includes pixels for a color different from the color of the pixels 10, the vertical signal line Cm may be connected to one of the two pixels 10 that are adjacent in the row direction among the multiple pixels 10 of the same color and the vertical signal line Cm+1 is connected to the other of the two pixels 10.

The control terminal of the switch 29 is connected to a switch control line COL. The conduction state of the switch 29 is controlled by controlling the potential of the switch control line COL. Whether to connect the vertical signal line Cm to the vertical signal line Cm+1 may thus be controlled as a result. The switch control line COL is connected to, for example, the controller 140 and the controller 140 controls the operation of the switch 29. Note that multiple switches 29 or the like may control whether three or more vertical signal lines C are to be connected to each other in the imaging device 101.

Operation of the imaging device 101 is described below.

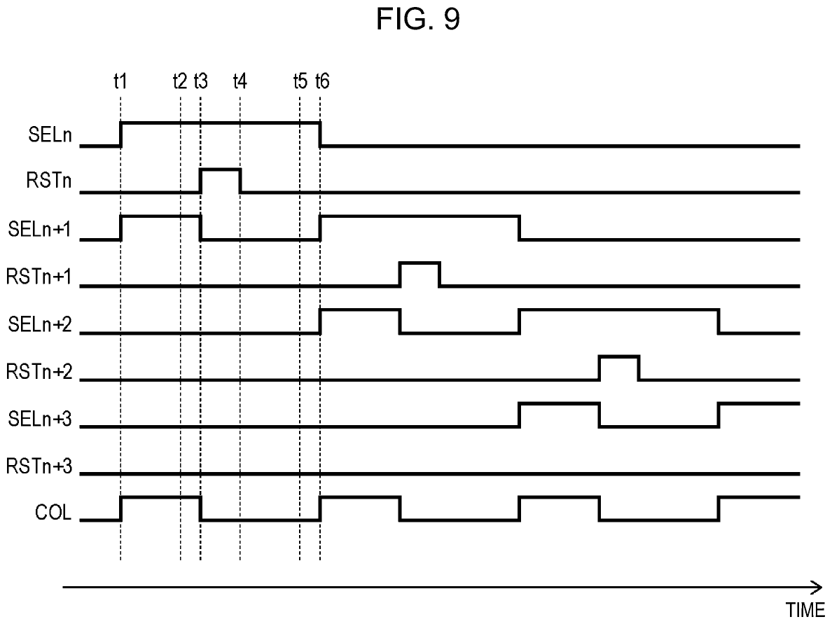

FIG. 9 is a timing chart of an operation example of the imaging device 101. FIG. 9 illustrates variations in the potential of the switch control line COL in addition to the same timing chart items as FIG. 4. The switch 29 is conductive with the potential of the switch control line COL at a high level or non-conductive with the potential of the switch control line COL at a low level.

The discussion of the operation example describes the operations of the pixels 10 at the m-th and (m+1)-th columns and the peripheral circuit corresponding thereto and operations that are the same as or similar to the operations described above are performed on the pixels 10 at the other columns. In the operation example described below, the (m+1)-th column of the pixels 10 is an example of a second column different from the first column.

The operation example of the imaging device 101 excluding the operation of the switch 29 is identical the operation example 1 of the imaging device 100. The following discussion focuses on the operation of the switch 29.

At time t1, the potential of the switch control line COL rises to a high level, causing the switch 29 to be conductive. Specifically, the vertical signal line Cm is connected to the vertical signal line Cm+1. At time t1 as well, the pixel signal of the pixel 10 at the n-th row and the m-th column and the pixel signal of the pixel 10 at the (n+1)-th row and the m-th column are output to the vertical signal line Cm and the pixel signal of the pixel 10 at the n-th row and the (m+1)-th column and the pixel signal of the pixel 10 at the (n+1)-th row and the (m+1)-th column are output to the vertical signal line Cm+1. Since the switch 29 is conductive, all these pixel signals are mixed.

At time t2, the signal processor 130 reads the pixel signals output to the vertical signal lines Cm and Cm+1. In this case, the pixel signals respectively read from the vertical signal lines Cm and Cm+1 are identical. For this reason, the signal processor 130 may use only one of the pixel signals read from the vertical signal lines Cm and Cm+1 to generate the image data or both of the pixel signals to generate the image data. When only one of the pixel signals is used, the signal processor 130 may be free from reading the other of the pixel signals.

At time t3, the potential of the switch control line COL falls to a low level, causing the switch 29 to be non-conductive. From time t3 to time t6, the imaging device 101 performs the same operation as the operation example 1 of the imaging device 100 from time t3 to time t6 with the switch 29 remaining non-conductive. Note that the potential of the switch control line COL may remain at a high level from time t3 to time t4 or from time t3 to time t6. In such a case, the resetting of the pixel 10 or both the resetting of the pixel 10 and outputting of the reference signal from the pixel 10 are performed with the vertical signal line Cm connected to the vertical signal line Cm+1.

At time t6 and thereafter, an operation that is the same as or similar to the operation at the n-th row is performed on the pixels 10 on a per row basis of all the (n+1)-th and subsequent rows. During the period while the pixel signals of the pixels 10 at each row are output, the potential of the switch control line COL is at a high level, connecting the vertical signal line Cm of the pixels 10 to the vertical signal line Cm+1.

In this operation example, for the first period (from time t1 to time t3), the switch 29 is conductive. In this way, the pixel signals of the pixels 10 at two rows and two columns are concurrently output to the vertical signal line Cm or the vertical signal line Cm+1 and are thus mixed. If the values of the pixel signals of the pixels 10 at the two rows and the two columns are at a similar level, the mutual conductance gm of the amplification transistor 24 is increased and the signals are averaged in a column direction. Horizontal direction resolution becomes half as high as in the operation example 1 of the imaging device 100 but since the pixel signals of the pixels 10 at the two rows and the two columns are concurrently output to the vertical signal lines Cm and Cm+1, further noise reduction characteristics and high-speed driving may be realized.

For the first period (time t1 to time t3) in the operation example described above, the pixel signals of the pixels 10 at the n-th and (n+1)-th rows are output to the vertical signal lines Cm and Cm+1 but the disclosure is not limited to this method. For the first period, the address control line SELn+1 does not rise to a high level and only pixel signals of the pixels 10 at the n-th row may be output to the vertical signal lines Cm and Cm+1. Specifically, when each row is read, the pixel signals of the pixels 10 at a row and two columns may be concurrently output to the vertical signal lines Cm and Cm+1 and then mixed. In this way, the effective gate width of the amplification transistor 24 is doubled and noise reduction characteristics and high-speed driving may thus be realized.

As long as the imaging device 101 performs the operation of causing the potential of the switch control line COL to rise to a high level during the period while each pixel 10 at each row outputs the pixel signal, the rest of the operation of the imaging device 101 may be identical to one of the operation example 2 through the operation example 4 of the imaging device 100.

### Alternative Embodiments

The imaging devices related to the disclosure have been described in accordance with the embodiments. The disclosure is not limited to the embodiments.

In the embodiments, the imaging device is a lamination-type imaging device including a photoelectric converter where the pixel electrodes, the photoelectric conversion layer, and counter electrodes are laminated on the semiconductor substrate. The disclosure is not limited to the lamination-type imaging device. The photoelectric converter in the imaging device is not limited to any particular type and the photoelectric converter may be, for example, a photodiode (PD) or a single photon-avalanche diode (SPAD) that is formed by being embedded in a semiconductor substrate.

In the embodiments, the signal processor generates the image data. The disclosure is not limited to this method. The image data may be generated by a different device. Also, the memory storing the reference signal may be included in the different device.

In the embodiments, each pixel includes the feedback circuit that negatively feeds back a signal to within the pixel. The disclosure is not limited to this configuration. For example, the imaging device may include a feedback circuit outside the pixel. When the effect of the reset noise is lower, the imaging device may be free from including the feedback circuit.

The imaging device described in each of the embodiments may not necessarily include all the elements described above but may be configured to include only an element that is used in a specific operation.

In the embodiments, an operation to be performed by a specific processor may be performed by another processor. The order of multiple operations may be modified or the multiple operations may be performed in parallel with each other.

In the embodiments, each element may be implemented by a software program appropriate for the element. The element may be implemented by a program executing unit, such as a CPU (central processing unit) or a processor, which reads a software program from a hard disk or a semiconductor memory, and executes the read software program.

The elements may be implemented by a hardware unit. The elements may be circuitry (or an integrated circuit). The circuitry may be a unitary circuit or include several circuits. Each of the circuits may be a general-purpose circuit or a specialized circuit.

Generic or specific form of the disclosure may be implemented by a system, an apparatus, a method, an integrated circuit, a computer program, or a recording medium, such as a computer-readable compact disc read-only memory (CD-ROM). The generic or specific form of the disclosure may be implemented by any combination of the system, the apparatus, the method, the integrated circuit, the computer program, and the recording medium.

The disclosure may be implemented as the imaging device in each of the embodiments, or as a control device controlling the imaging device, or as a program causing a computer to execute a driving method of the imaging device performed by a processor, such as a control circuit, or as a computer-readable non-transitory recording medium having stored the program.

Without departing from the spirit of the disclosure, a variety of changes that are conceived by those skilled in the art and applied in the embodiments and the examples thereof may fall within the scope of the disclosure and another embodiment that is constructed by combining a subset of the elements in the embodiments and the examples thereof may also fall within the scope of the disclosure.

The imaging device and the imaging method thereof in the disclosure may be applicable to a variety of camera systems and sensor systems, including digital still cameras, broadcast cameras, professional cameras, medical cameras, monitoring cameras, car cameras, digital single-lens reflex cameras, and digital mirror-less single-lens reflex cameras.

What is claimed is:

1. An imaging device comprising:
a plurality of pixels arranged in a matrix of rows and columns;
a signal line arranged for each column of the pixels; and
a controller,
wherein each of the pixels includes a photoelectric converter that converts light into signal charges, and
wherein the controller causes each of the pixels to output to the signal line a pixel signal corresponding to an amount of the signal charges accumulated in the pixel and a reference signal after the pixel is reset,
during a first period in which a first pixel at a first row is caused to output the pixel signal, causes a second pixel that is arranged at a second row different from the first row and at a first column in which the first pixel is arranged to output the pixel signal, and
causes the second pixel to re-output the pixel signal before resetting the second pixel but after the first period.

2. The imaging device according to claim 1, wherein the controller resets the first pixel after causing the first pixel to output the pixel signal and causes the first pixel to output the reference signal after the resetting.

3. The imaging device according to claim 1, further comprising a signal processor,
wherein the signal processor generates image data in accordance with the pixel signals output by the first pixel and the second pixel during the first period and the reference signal output by the first pixel.

4. The imaging device according to claim 1, wherein, after causing the first pixel to output the reference signal, the controller causes the first pixel to accumulate the signal charges and then to output the pixel signal.

5. The imaging device according to claim 1, further comprising a signal processor,
wherein the signal processor generates image data in accordance with the reference signal output by the first pixel, the reference signal output by the second pixel, and the pixel signals output by the first pixel and the second pixel during the first period.

6. The imaging device according to claim 5, further comprising a memory that stores a signal corresponding to the reference signal.

7. The imaging device according to claim 1, wherein the controller causes a third pixel that is arranged at the first column and at a third row that is different from the first row and the second row to output the pixel signal during the first period, and
causes the third pixel to re-output the pixel signal before resetting the third pixel but after the first period.

8. The imaging device according to claim 1, further comprising a switch connected between the signal line arranged for the first column and the signal line arranged for a second column different from the first column,
wherein the controller causes the switch to conduct during the first period.

9. The imaging device according to claim 1, wherein each of the pixels comprises a feedback circuit that negatively feeds back reset noise.

10. The imaging device according to claim 1, wherein the controller causes the second pixel not to output the reference signal during a second period in which the first pixel is caused to output the reference signal.
